(19) United States
(12) Patent Application Publication
(10) Pub. No.: US 2018/0345861 A1
(43) Pub. Date: Dec. 6, 2018

(54) AUTOMATICALLY ADJUSTABLE MIRROR ASSEMBLY

(71) Applicant: MCi (Mirror Controls International) Netherlands B.V., Woerden (NL)

(72) Inventor: Bastiaan Huijzers, Woerden (NL)

(73) Assignee: MCi (Mirror Controls International) Netherlands B.V., Woerden (NL)

(21) Appl. No.: 15/527,824

(22) PCT Filed: Nov. 19, 2015
(86) PCT No.: PCT/NL2015/050811

§ 371 Date: May 18, 2017

(30) Foreign Application Priority Data
Nov. 19, 2014 (NL) 2013827
Mar. 27, 2015 (NL) 2014538

(51) Int. Cl. B60R 1/072; B60R 1/074; G07C 5/10; H02P 6/00; H02P 6/30

(52) U.S. Cl. CPC B60R 1/072; B60R 1/074; B60R 16/0238; H02P 6/007; H02P 6/30; G07C 5/10

(57) ABSTRACT

An adjustable vehicle mirror assembly uses a revolution sensor for detecting revolutions of an element in a mirror rotation drive chain. A control circuit uses the revolution sensor control rotation of the mirror to a preset orientation by counting revolutions and controlling a motor power supply and its direction dependent on whether the count indicates that the count of revolutions has reached a preset value. At power down, power up or when a new preset value is defined the control circuit switches to an overrule state in order to calibrate an offset. The control circuit continues operating in the overrule state until a rotation coupling in the mirror assembly reaches a disengaged state or stalls.

### FIELD OF THE INVENTION

The invention relates to an automatically adjustable mirror assembly for a vehicle.

### BACKGROUND

An automatically adjustable rear view mirror assembly for a vehicle contains a mirror and a motor coupled to the mirror by a gear system, to adjust the orientation of the mirror in order to adapt the rear viewing angle provided by the mirror. Rear view mirror assemblies with one and two adjustable angles are known. A manually controllable switch or switches may be provided to control actuation of the motor until a desired rear viewing angle is realized. A disengaging coupling (e.g. a slipping coupling) may be used to enable direct manual adjustment of the mirror orientation or to prevent motor overload when the motor keeps running while (further) rotation of the mirror is blocked. Disengagement occurs when the mirror has reached a stop angle. In mirror assemblies with a first and second adjustable angle of orientation, e.g. around the x and y axes, the stop angle for the first adjustable angle may depend on the value of the second adjustable angle and vice versa.

The rear view mirror assembly may be configured to actuate the motor automatically in order to adjust the mirror orientation to a preselected orientation. For this purpose the assembly may be provided with one or more sensors for determining the orientation of the mirror. This makes it possible to actuate the motor automatically, until the orientation corresponding to the preselected orientation is reached.

An indirect measurement of the mirror orientation from the rotation of the motor or one of the gear wheels may be used as an alternative to direct measurement. But a problem may arise when the motor is coupled to the mirror via disengaging coupling that interrupts transmission when the transmitted torque exceeds a threshold. Once disengagement has occurred, for example because the user has manually adjusted the mirror, it becomes uncertain how many revolutions will be needed to reach the preselected orientation. Thus disengagement may make it preferable to measure the orientation from the mirror itself, or from a part that is rigidly coupled to the mirror itself, but this complicates the mirror assembly.

### SUMMARY

Among others it is an object to provide for measurement of an orientation parameter of the mirror of a mirror assembly for a vehicle.

An adjustable vehicle mirror assembly is provided, comprising

an electric motor, a mirror and a gear train for translating rotation of the electric motor into changes of an angle of orientation of the mirror, the gear train comprising a disengaging coupling;
a motor power supply and direction control switch;
a revolution sensor for detecting revolution of an element in the gear train or a rotation axle of the electric motor;
a control circuit coupled to the revolution sensor and the motor power supply and direction control switch, the control circuit being configured to
count net full or partial revolutions of the element based on signals from the revolution sensor, and to control supply of power to the motor and its direction dependent on whether the count indicates that the net full or partial revolutions have reached a preset value,
   switch to an overrule state and control supply of power to the motor and its direction automatically according to a predetermined direction when in the overrule state, a least state until the disengaging coupling reaches a disengaged state and/or until the electric motor stalls because a transmitted torque exceeds a threshold.

Switching to the overrule state is used to determine a count value corresponding to a known mirror orientation. Switching to the overrule state can be used to rotate the mirror to a known orientation, which is known from the kind of disengagement that has occurred. When the mirror orientation is the result of rotation around one axis of rotation, the known orientation may correspond to an angle of orientation at which the disengaging coupling disengages or the motor stalls. However, the known orientation may also be realized based on a combination of disengagements or stalls, e.g. by rotating the mirror to a count midway between counts at disengagements and/or motor stalls upon motor rotations in opposite direction. When the mirror orientation is the result of rotation around more than one axis of rotation, the known orientation may correspond to a combination of disengagements or motor stalls.

When the revolution count is reset to a predetermined value when the mirror is in the known orientation, it is ensured that the preset value based control of the control of the angle of orientation subsequently results in a predictable orientation of the mirror. The reset may be performed after the disengaged state or motor stall has been reached. But the reset need not be a stepped coupled to operation in the overrule state. The overrule state can be used to rotate the mirror to the known orientation corresponding to the disengaged state or motor stall at the time when the user causes the power from the vehicle to be switched off. In this case the reset may be a standard reset performed when the power is subsequently switched on.

In an embodiment, the control circuit switches to the overrule state when the power is switched on. In this embodiment the reset may performed once it is certain that the overrule state has brought the orientation of the mirror to a predetermined disengagement state or stall state. This may be the case for example after a predetermined time interval and/or when a disengagement detector detects disengagement. In a further embodiment, a switch to the overrule state may be made both on power down and power up. In this case, the overrule state in response to power-down need not reach a known orientation: the overrule state in response to power-up may be used to complete movement to the orientation of the mirror corresponds to the predetermined disengaged state or stall state. The overall time needed to reach this disengaged state or stall state can be several seconds, e.g. four seconds, which is noticeable as a waiting time for the user. By using the overrule state both on power down and power up, the waiting time on power up can be reduced.

In an embodiment the overrule state is applied in synchronism with power fold in or out of the mirror housing. This reduces or eliminates the time that the mirror cannot be used due to the overrule state only.

In an embodiment the control circuit is configured to select the predetermined direction according to whether the value of the count when switching to the overrule state is above or below a threshold value. The gear train disengages or the motor stalls at positions on opposite ends of the adjustable rotation range of the mirror, both of which correspond to a predetermined angle of orientation. By making it possible to rotate to the nearest angle in the overrule state, the wait time caused by the overrule state can be reduced.

In an embodiment, the control circuit is configured to supply information about a current orientation of the mirror upon receiving a request signal. In this embodiment the control circuit switches to the overrule state in response to the request signal, and determines the revolution count needed to reach the disengaged state from the position at the time of the switch to the overrule state. From this information a preset value can be determined that results in reproducible angles of orientation.

In an embodiment, the control circuit comprises a timer and/or a disengagement detector configured to detect an indication of disengagement of the disengaging coupling, the control circuit being configured to switch off the overrule state in response to detection by the timer that a predetermined time interval has elapsed since switching to the overrule state and/or in response detection of the indication of disengagement by the disengagement detector. Use of a disengagement detector reduces the wait times.

### BRIEF DESCRIPTION OF THE DRAWING

These and other objects and advantageous aspects will become apparent from a description of exemplary embodiments, with reference to the following figures

FIG. 1 schematically shows an orientation adjustment mechanism of a rear view mirror assembly

FIG. 2 shows an electric circuit of a rear view mirror assembly

FIG. 3 shows a control circuit

FIG. 4-6 show flow-charts of operation

FIG. 7 show a diagram illustrating two dimensional mirror orientation

### DETAILED DESCRIPTION OF EXEMPLARY EMBODIMENTS

### Mirror Rotation

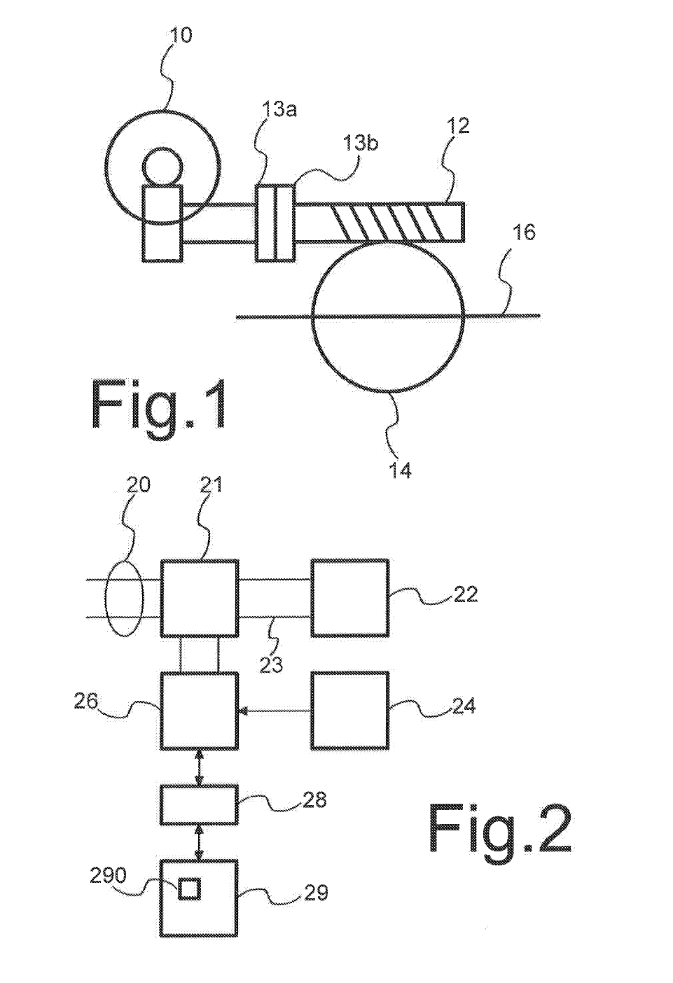

FIG. 1 schematically shows an exemplary orientation adjustment mechanism of a rear view mirror assembly with a slip-coupling. In this example, the orientation adjustment mechanism comprises a motor unit 10, a worm axle 12, a toothed wheel 14 and a mirror 16. Motor unit 10, worm axle 12, and toothed wheel form a gear train for using an electric motor in motor unit 10 to drive rotation of mirror 16. This gear train reduces the number of revolutions of toothed wheel 14 with respect to revolutions of the motor. Motor unit 10 may comprise an intermediate gear train that is part of the gear train, and operable between the motor and worm axle 12, or the motor may drive worm axle 12 directly. Motor unit 10 may be mechanically coupled to worm axle 12 by means of engaged teeth. Similarly, worm axle 12 may be mechanically coupled to toothed wheel 14 by means of engaged teeth, e.g. via teeth in screw shape on worm axle 12. Toothed wheel 14 is connected to mirror 16 so that the orientation of mirror 16 rotates when toothed wheel 14 rotates.

In operation, rotation of the motor in motor unit 10 is used to rotate the orientation of mirror 16 relative to the housing (not shown) of the rear view mirror assembly around a first rotation axis. In addition to the parts shown in FIG. 1, the rear view mirror assembly may contain additional components, such as components to rotate the orientation of mirror 16 relative to the housing around a second rotation axis and/or a power fold mechanism to rotate the housing relative to the vehicle to which the rear view mirror assembly is attached. Such a power fold mechanism may comprise a hinge around which the mirror housing is rotatably mounted and a motor coupled between the housing and a vehicle side part of the mirror assembly, to rotate the housing around the hinge.

The adjustment mechanism comprises a slip coupling. The term “slip coupling” will be used to indicate disengaging couplings in general. It will be understood that the described embodiments also work when disengagement is realized other than by slipping. By way of example a slip coupling may be realized by using a two part worm axle 12 with abutting ends 13a,b mechanically coupled to each other by friction. The slip coupling provides for slip between rotation of the motor of motor unit 10 and orientation changes of mirror 16 when a relative force above a threshold is exerted. This ensures that the motor of motor unit 10 may continue to rotate when mirror 16 is stopped by a mechanical stop, and/or that mirror 16 can be rotated by hand without corresponding rotation of the motor. It will be appreciated that the slip coupling can be realized in different ways and at one or more different positions in the gear train.

### Orientation Control

FIG. 2 shows an electric circuit of a rear view mirror assembly. The circuit comprises a power supply input 20, a power/direction switch 21, the electric motor 22 of the motor unit, a revolution sensor 24, a control circuit 26 and optionally a control input 28. A control device 29 outside the electric circuit of a rear view mirror assembly may be coupled to control circuit 26 via control input 28. By way of example, an in-vehicle communication bus may be used for this purpose (e.g. a LIN bus or a CAN bus). Control device 29 may comprise a memory 290 for storing one or more preset values. In an embodiment, a removable memory may be used, e.g. a memory in a portable car key device. Supply input 20 is connected to electric motor 22 via power/direction switch 21. Control circuit 26 has inputs coupled to an output of revolution sensor 24 and optionally to control input 28. Control circuit 26 has an output coupled to a control input of power/direction switch 21.

Revolution sensor 24 is configured to sense revolutions of electric motor 22, or of a part of the gear train by which electric motor 22 is mechanically coupled to the mirror. By way of example, revolution sensor 24 may a current ripple detector coupled to a power supply line 23 of electric motor 22 (connection not shown) to detect revolutions from ripples in the power supply current through electric motor 22.

The power supply current may be sensed for example from a voltage drop over a resistor connected in series with electric motor 22, or from a voltage drop over electric motor 22, which occurs because of such a resistor and/or due to a non-zero effective output impedance of the power supply of the motor.

Ripples are AC variations superimposed on a signal that represents the average (DC) motor current. The ripple detector is configured to convert these AC variations to a binary signal, e.g. with logic one and zero values when the current is above or below the average, or with pulses in a binary signal each time when the current crosses the average. The ripple detector may comprise a low pass filter coupled and a comparator configured to compare a current sensing signal with a version of the current sensing signal that has been filtered by the low pass filter. In another embodiment, the ripple detector may comprise a high pass filter and an amplifier for amplifying a high pass filtered signal from the high pass filter to a binary signal.

As another example, revolution sensor 24 may be an optical sensor directed at an element in the gear train (e.g. the axle of electric motor 22) to detect revolution from reflections of interruptions of transmissions by an element on the axle. As will be appreciated, revolution sensor 24 may generate one detection pulse for every full circle revolution of the element in the gear train, or a plurality of pulses for every full circle revolution, e.g. if more than one ripple is generated during a revolution, or a plurality of reflecting portions is present on the element.

In operation, control circuit 26 controls when the mirror of the rear view mirror assembly is rotated with respect to the housing of the assembly. When the mirror has to be rotated to a predefined angle, which may be indicated by control device 29 on the basis of a value stored in its memory 290 for example, control circuit 26 uses a sensor signal from revolution sensor 24 to infer whether the mirror has reached the predefined angle, and to control power/direction switch 21 to keep motor 22 running until the control circuit 26 infers that the predefined angle has been reached.

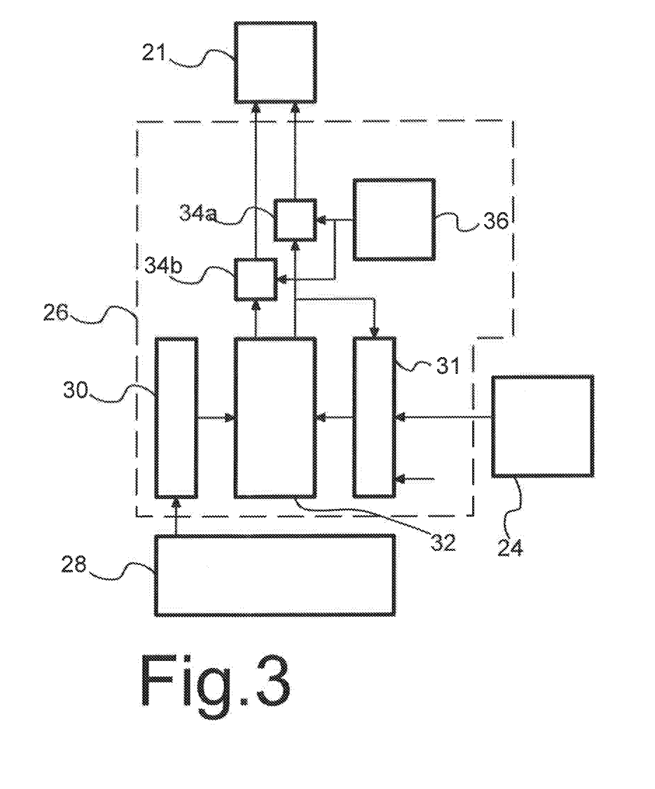

FIG. 3 shows an example of a circuit that may be used in control circuit 26 to control power/direction switch 21. In the example, control circuit 26 comprises a set value register 30, an up/down counter 31, a comparator 32, logic gates 34a-b, and a power-down detector 38. Set value register 30 is coupled to control input 28, and serves to store a set value received from that input. Up/down counter 31 has a count input, an up-down control input and a reset input. The reset input may be coupled to a circuit node (not shown) that provides a reset signal when the control circuit is powered up. Up/down counter is configured to set its count value to a default value, preferably zero, upon receiving a reset signal. The count input is coupled to an output of revolution sensor 24. Comparator 32 has inputs coupled to set value register 30 and up/down counter 31. Comparator 32 has an equality signal output and a sign signal output coupled to power/direction switch 21 via a first and second logic gate 34a-b respectively. First and second logic gate 34a-b have further inputs coupled to an output of overrule control circuit 36. First and second logic gate 34a are logic gates that pass the equality signal and the sign signal (optionally inverted) to power/direction switch 21 when overrule control circuit 36 indicates the absence of an overrule state. First and second logic gate 34a are logic gates that output predetermined values, corresponding to a non-equality indication by the equality signal and a predetermined value of the sign signal to power/direction switch 21 when overrule control circuit 36 indicates an overrule state. NAND gates or other logic gate circuit or combinations of such circuits may be used for example.

### Overrule Control

In an embodiment, overrule control circuit 36 may comprise a power-down detector. The power-down detector may be coupled to a circuit (not shown) in the vehicle that provides a power-down signal when the control key of the vehicle is turned off but before power supply ceases. Alternatively, the power-down detector may be a configured to detect a start of power-down from a reduction of the external power supply voltage. The power down detector may furthermore be coupled to a control input of a “power fold” motor (not shown) that is configured to fold the housing of the mirror assembly. In contrast with this power/direction switch 21 merely serves to rotate the orientation of the mirror relative to the housing.

In operation a count value in up/down counter 31 changes in response to signals (e.g. pulses) from revolution sensor 24. Dependent on whether one or more signals are generated for a full circle revolution, the count represents a number of full circle revolutions of the element from which the revolutions are sensed, or a multiple of this number. Up/down counter 31 counts up or down dependent on a signal at the up/down control input.

An equality signal from equality signal output of comparator 32 indicates whether or not a count value in up/down counter 31 equals a set value in set value register 30. The equality signal is used to control power/direction switch 21 to supply current to electric motor 22 when the equality signal indicates inequality (non-equality). A sign signal output of comparator 32 indicates whether the count value is lower or higher than the set value. The sign signal is used to control power/direction switch 21 to selected the polarity of the supply current to electric motor 22. Thus, the control circuit causes electric motor 22 to rotate until the count value equals the set value.

### Using an Overrule State to Rotate to Known Mirror Orientations

The output of a overrule control circuit 36 is used to overrule this normal form of control of electric motor 22. Overrule control circuit 36 36 forces first and second logic gates 34a-b to control power/direction switch 21 to supply current to electric motor 22 to rotate electric motor 22 in a predetermined direction after overrule detector 38 detects an overrule state. This is used to ensure that the mirror will be in a known mirror orientation against a stop that causes the gear train to slip or the motor to stall (stop running because it cannot supply sufficient torque to cause rotation) after completion of the overrule. In practice this may take between one and ten seconds. In the following, what is said about slip conditions also applies to motor stall positions, unless this is clearly not applicable.

When overrule control circuit 36 comprises a power-down detector it may be configured to signal the overrule in response to detection of a power down state, to ensure that the mirror is in the known mirror orientation at the completion of power-down. As a result, the mirror will be in the known mirror orientation on power up, so that a set value loaded in set value register on power up will correspond to a predetermined angle of mirror orientation. When the power down detector is also used to control a power fold motor, the rotation of the mirror relative to the housing occurs simultaneously with rotation of the housing.

It will be appreciated that the same function may be realized by means of alternative circuits. For example, in another embodiment a preset value may be loaded into the up/down counter, and a non-zero and sign output of the up/down counter may be used to generate the equality and sign signals. Instead of using the full count from the up/down counter only a most significant part may be used.

Control circuit 26 may comprise a timer circuit configured to maintain the overrule state for a predetermined amount of time sufficient to rotate electric motor 22 to the known mirror orientation, or control circuit 26 may comprise a slip detector, configured to disable motor rotation once slip or motor stall is detected. Overrule control circuit 36 may comprise the timer or the slip detector for this purpose, e.g. in combination with a power-down detector and a logic circuit configured to generate control signals for logic gates 34a,b. The slip detector may be configured to detect a current increase in the average motor current associated with an increased motor force needed to cause slipping. Alternatively, disengagement may not be required, but motor stall (when the motor stops running because it cannot supply sufficient torque to cause rotation) may be detected, e.g. from excessive current or absence of detected revolution. Alternatively, slipping may be detected by detecting relative movement of parts of the slip coupling, e.g. by means of a switch or an optical detector. Use of slip detection to terminate the overrule state makes it possible to use less time than with the timer embodiment.

Control circuit 26 may be integrated in an application specific integrated circuit (ASIC), e.g. in a circuit wherein one or more application specific connection layers are used to connect transistors or more complex circuit blocks into a circuit configured to perform the described functions. The ASIC may be provided with a bus interface for communication via an in vehicle bus, which is connected to a collection of in vehicle manual control input devices and actuators.

In an alternative embodiment control circuit 26 may comprise a microcontroller with a program to perform a similar function. The program may maintain a count corresponding to that of up/down counter 31 in a memory of the micro-controller as well as information about a current motor control.

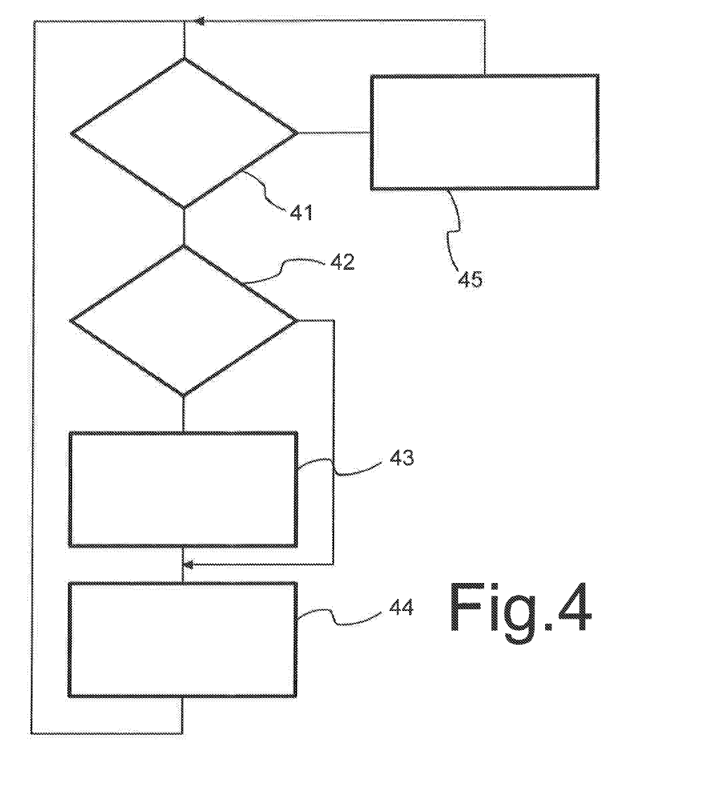

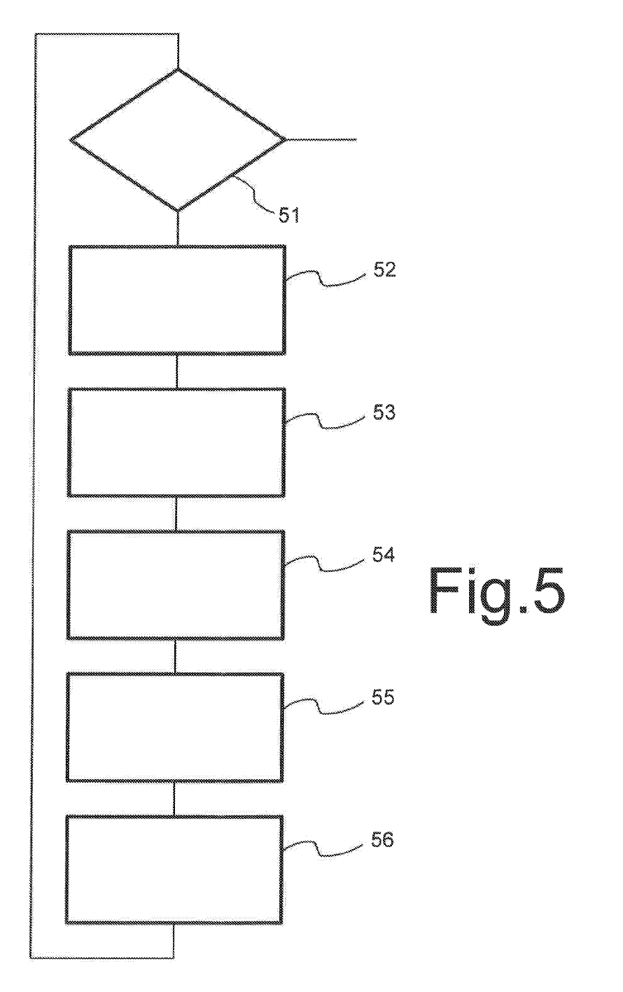

FIG. 4 shows a flow-chart of operation in this embodiment. In a first step 41, the program causes the microcontroller to test whether an overrule state applies. If not the program causes the microcontroller to execute a second step 42, wherein the microcontroller tests whether it has received a signal from revolution sensor 24. If so, the program causes the microcontroller to execute a third step 43, to increment or decrement the count, dependent on the current motor direction. If no signal from revolution sensor 24 has been received, or third step 43 has been executed, the program causes the microcontroller to execute a fourth step 44, wherein the microcontroller sets the motor control. Motor control is set to “no movement” if the count equals a preset value, or alternatively when the count is in a predetermined range that includes the preset value. Otherwise, motor control is set to “movement” and to a first or second direction of movement dependent on whether the count is above or below the preset value or the predetermined range. From fourth step 44, the program causes the microcontroller to repeat from first step 41.

In an embodiment a step may be inserted between first step 41 and fifth step 45, to test whether time out and/or slip occurs e.g. based on a time count and/or an output signal form a slip detector, and if so to set motor control to “no-movement”, optionally to set the count to a predetermined value, and return to first step 41.

The test in first step 41 may comprise detecting whether a power down state exists, and deciding to apply the overrule state if so. If first step 41 indicates that the overrule state applies the program causes the microcontroller to execute a fifth step 45, wherein the microcontroller sets the motor control to “movement” and a predetermined direction. From fifth step 45, the process may be repeated from first step 41.

Although embodiments have been described wherein the overrule state is used only to rotate the mirror to an angle of orientation that corresponds to slipping or motor stall, it should be appreciated that alternatively, the overrule state may be used to rotate the mirror other known orientations. For example, fifth step 45 may be replaced by a first and second further step (not shown). In the first further step the microcontroller sets the motor control to rotate the mirror in a first direction until slip or motor stall occurs, as determined e.g. by time-out or disengagement detection. In the second further step the microcontroller sets the motor control to rotate the mirror in a second direction, opposite to the first direction. In the second further step the microcontroller counts the number of revolutions during movement in the second direction and stops the motor when a predetermined count has been reached, e.g. a count corresponding to half the count of revolutions needed to rotate between opposite slipping conditions. In this way, a known mirror orientation can be realized that does not need to correspond to a slipping condition.

In a further embodiment a step may be added wherein the microprocessor measures the count of revolutions needed to rotate between the opposite slipping conditions or motor stall conditions. In this embodiment, before reaching the slipping state by movement in the first direction, the microcontroller sets the motor control to rotate the mirror in the second direction until a slipping state or motor stall state is reached. Subsequently the microprocessor counts revolutions during rotation in the first direction until the slipping state is reached.

### Conditions for Entering the Overrule State

Instead of, or in addition to using power-down to generate an overrule control signal, control circuit 26 (whether implemented using a program or not) may be configured to cause an overrule of the normal form of control of electric motor 22 on detecting power up. In this way it can be ensured that the orientation of the mirror will be in the predetermined position before use but after power up. The timer or slip detector may be used to terminate the overrule state in this case. In the flow chart, first step 41 may involve testing whether a power up has occurred and no time out and/or slip detection has occurred since power up, and to proceed to fifth step 45 if so, and to terminate the overrule state, and proceed to second step 42 otherwise. Optionally, first step 41 may comprise setting the count to a predetermine value time out and/or slip detection is detected. This may be useful if, as will be explained for other embodiments, the overrule state is used outside power-down.

In the circuit embodiment, overrule control circuit 36 may comprise a power up detector, a logic circuit and a timer and/or slip detector, the logic circuit being configured to control logic gates 34a,b to overrule the signals to power/direction switch 21 in this way. Although overrule may be applied only on power-up, use of overrule on both power-down and power up has the advantage that it may reduce the amount of time when mirror control is not available due overrule on power up. In practice reaching a slip state may take between one and ten seconds, and the part of this time that occurs at power on can be reduced, even if it is not made zero by using overrule on power down.

In a further embodiment control circuit 26 (whether implemented using a program or not) may be configured to apply the overrule state also at other times than power down and/or power up. This may be the case for example when a user issues a command to store a new preset value for controlling a preset angle of orientation of the mirror. For example, control device 29 may comprise a control button to trigger storage of such a preset in its memory after the user has manually adjusted the angle (e.g. by pressing the mirror or by manually overruling motor control). In this case, control device 29 may send a request to control circuit to supply information about a current angle. In other embodiments, double user actuation of a preset control button or other user commands may be used to trigger a switch to the overrule state.

In other embodiments other conditions may be used to trigger application of the overrule state. In a number of embodiments, detection of signals that measure effects associated with external mirror adjustment may be used to trigger application of the overrule state. In other embodiments a detector uses independent sensing of mirror orientation to detect time points when the mirror orientation assumes a predetermined position and to test for deviations between an expected count for that mirror orientation and the count determined by means of the revolution sensor at that time point.

In an embodiment that uses effects accompanying external mirror adjustment, the drive train may be arranged to couple the electric motor to the mirror so that the drive train transmits rotation to the electric motor in the case of manual adjustment. In this embodiment, an induction detector is included in the mirror assembly, coupled to the electric motor. The induction detector is used to detect an induction voltage or current produced by the electric motor as a result of the rotation. The control circuit is configured to switch to the overrule state in response to detection of the induction.

In a further embodiment the mirror assembly may comprise a capacitor and a circuit to charge or discharge the capacitor in response to the induction current or voltage from the motor. In an embodiment, the motor is coupled to the capacitor via a diode to charge the capacitor. In another embodiment, the motor is coupled to a control input of a switch (e.g. a transistor) to discharge the capacitor (or charge it e.g. from a sleep state power source). A detector coupled to the capacitor may be used to trigger application of the overrule state by the control circuit if the voltage across the capacitor has crossed a predetermined threshold, due to charging or discharging.

In an embodiment, this may be used (or also be used) to respond to manual adjustment that occurred when the vehicle was switched off, the detector triggering application of the overrule mode when the vehicle is switched on if the voltage across the capacitor has crossed the predetermined threshold.

In another embodiment that uses effects accompanying external mirror adjustment, a pressure controlled switch in the mirror assembly is used. The mirror may be connected to the pressure controlled switch so that pressure exerted on the mirror is transmitted to the pressure controlled switch, to close or open the switch. In this embodiment, the switch is coupled to the control circuit and the control circuit is configured to apply the overrule state in response to switching of the pressure controlled switch.

In another embodiment that uses effects accompanying external mirror adjustment, a clutch may be used in the transmission chain. External adjustment of the mirror has the effect of declutching this clutch. In this embodiment the mirror assembly has a detector for detecting declutching. The output of this detector is coupled to the control circuit, which is configured to apply the overrule state when the switch indicates that declutching has taken place.

In further embodiments, such a declutching switch or pressure controlled switch may coupled to a capacitor and a detector in the mirror assembly. The switch may be configured to discharge or charge the capacitor when it is switched. In these embodiments a detector is coupled to the capacitor and the control circuit. The detector is configured to trigger application of the overrule state if the voltage across the capacitor has crossed a predetermined threshold.

In an embodiment, this may be used (or also be used) to respond to manual adjustment that occurred when the vehicle was switched off, based on the remaining charge on the capacitor. A charging circuit may be provided to charge the capacitor when the vehicle is switched on, at a lower charging rate than a discharging rate due to closing of the pressure controlled switch.

Earlier declutching may also be detected from the occurrence of play in the transmission chain. Play may also arise due to external adjustment without declutching. The control circuit may be configured to detect play by monitoring the size of initial current through the electric motor in the mirror assembly following application of a voltage to the electric motor, and to compare the initial current with a predetermined threshold to detect play. The control circuit may be configured to apply the overrule state when play is detected.

In an embodiment that uses independent sensing for detecting mirror orientation, an optical detector and an optical marker may be included in the mirror assembly, on respective parts of the mirror assembly between which relative motion occurs when the electric motor drives the mirror. The optical marker may be a transition between a reflective area and a non reflective area, e.g. a white and black area, or a mirror area and a non mirror area. Alternatively, the optical marker may be a transition between optically transmissive and non-transmissive areas. The optical detector may comprise a light source and a light detector to detect reflection or transmission of the light from the light source by the optical marker.

In this embodiment the optical detector is coupled to the control circuit, and the control circuit is configured to compare the value of the count of revolutions at the time of detection of the optical marker with an expected count value and to switch to the overrule state if the two values differ by more than a predetermined threshold. Thus, when the mirror is rotated to a preset position and this results in detection of the optical marker, overrule is used to recalibrate if the two values don't match.

Preferably the optical marker or the optical detector is located on a part of the mirror assembly that results in detection at no more than one mirror orientation during mirror orientation adjustment. This ensures that the detection of the optical marker corresponds to a unique orientation. However, even if the optical marker can be detected at more than one orientation, the detection may be used to trigger the overrule statr. For example the control circuit may test whether the expected count values for all orientation at which detection can occur differ by more than a threshold from the value of the count of revolutions at the time of detection.

In another embodiment that uses independent sensing for detecting mirror orientation, a motor current fingerprint is used in the mirror assembly. During rotation, motor current fluctuates due to load variations as a result of minor imperfections in the transmission train. Such imperfections may be accidental results of manufacturing tolerance, or they may be provided on purpose, for example by including roughened patches in the transmission chain or adding springs that act locally against parts of the transmission chain. The same pattern of fluctuations will arise each time the motor rotates the transmission train through the same positions. This pattern is called the motor current fingerprint.

In this embodiment, the control circuit has a memory wherein information representing an exemplary fingerprint is stored. The mirror assembly comprises a current sensor (the sensor used for providing input to the ripples detector may be used) and the control circuit is configured to compute correlation coefficients of measured current patterns with the stored fingerprint as a function of the time point that defines when the measured current patterns occurred. The control circuit is configured to use the time point of maximum correlation instead of the time of detection of the optical marker of the previous embodiment.

The compared fingerprints may simply be a series of current values for successive time points, but this is not necessary. Instead derived values may be used in the fingerprint, such as peak amplitudes of successive current ripples, values of a filtered version of the current signal, Fourier transforms of the current etc. For example, a filter may be used that filters our ripples.

Although the described embodiments apply the overrule state when independent sensing of the mirror orientation indicates a deviation from the expected revolution count, it should be appreciated that alternatively the independent sensing results may be used to set the revolution count, e.g. by setting the revolution count so that a predetermined value is associated with the time point when independent sensing indicates a specific mirror orientation, or to readjust the target count value at which rotation has to be stopped accordingly. Dependent on the accuracy of the sensing result, this may make driving the electric motor to disengagement superfluous.

As will be appreciated, at least part of these techniques provide for an estimation of the mirror orientation. Each of these estimations may be used to determine a reference for the count of the number of net full or partial revolutions of the element based on signals from the revolution sensor for use to control supply of power to the motor and its direction dependent on whether the count indicates that the number of net full or partial revolutions has reached a preset value. In that case it is not needed to drive the disengaging coupling until it reaches a disengaged state and/or until the electric motor stalls because a transmitted torque exceeds a threshold. However, driving into disengagement provides a convenient way to determine the reference for the count that can always be applied.
Determining Information about a Current Angle of the Mirror

FIG. 5 shows the steps performed by control circuit 26 in order to supply information about a current angle of the mirror. In a first step 51 control circuit 26 determines whether information about the current angle of the mirror needs to be supplied. If not, control circuit 26 proceeds to normal operation as illustrated by means of FIG. 4 (not shown in FIG. 5). If information about a current angle of the mirror must be supplied, control circuit 26 executes a second step 52, wherein it resets the count value or copies the current count value into memory. In a third step 53, control circuit 26 applies the overrule state until a slip condition is reached, as determined by a time out and/or a slip detector. In a fourth step 54, control circuit 26 reads the count value reached after third step 53.

In a fifth step 55, control circuit 26 derives and supplies the information about a current angle of the mirror based on the count value read out in fourth step 54. If second step 52 involves a reset, the negative of the count value read out in fourth step 54 may be used. If second step 52 involves copying, the difference between the count value read out in fourth step 54 and the count value copied in second step 52. The information may represent the count or difference, or a number derived from it, for example by adding an offset, scaling and/or rounding.

In a sixth step 56, control circuit 26 sets its preset value according to the count or difference and resets the count value. The preset value is selected so that the process of the second step and following of FIG. 4 will return the mirror to its position at the time of the copying step (second step 52 of FIG. 5). From sixth step 56 control circuit returns to the first step of the process of FIG. 4, so that the mirror will return to the angle that it had in second step 52.

Although this process has been described by a flow chart that may be realized by execution of a program stored in a microcontroller in control circuit 26, it should be appreciated that the same process may be realized by a dedicated circuit, e.g. by resetting the up/down counter 31 before applying the overrule state, and reading the count value from the up/down counter 31 once the overrule state has realized a slip condition, as determined by a time out and/or a slip detector.

Control device 29 may receive the information about a current angle of the mirror supplied in fifth step 55, and store it for use to supply preset values in the future. As will be appreciated, this has the effect that even if the mirror has been adjusted manually or the motor has slipped before the copying in second step 52, a mirror setting is obtained that can be reproduced by returning the angle of mirror orientation to a predetermined position before angle control

In an embodiment, control circuit 26 may be configured to apply the overrule state in response to a manual user control, and to reset the count value upon reaching the slip state as a result without storing a new preset value. This provides for correction when for some reason effect the mirror has been adjusted manually or the motor has slipped, so that the mirror is no longer oriented according to an earlier preset value. Alternatively, the user can correct this by manually adjusting the mirror triggering storage of a new preset value.

### Direction Selection in the Overrule State

Although embodiments have been shown wherein the overrule state results in rotation of the electric motor in a predetermined direction, this is not necessary. In an alternative embodiment, control circuit 26 is configured to select the direction of rotation dependent on the current position of the electric motor at the time of entering the overrule state. For example, control circuit 26 may be configured to select the direction dependent on the expected times needed to reach a slip condition by rotation of the electric motor in a first and second direction. The direction with the smallest direction may be selected for example. This has the advantage that the time needed to reach a slip position can be reduced.

In this embodiment, it is desirable to take a total count N of signals from revolution sensor 24 corresponding to rotation of the mirror from one slip position to the other into account. Dependent on whether the overrule state was used to rotate the mirror to a first slip position or a second slip position last prior to entering a preset value, the total count N is added to the preset count value or not. This may be done for example in control device 29 or in control circuit 26.

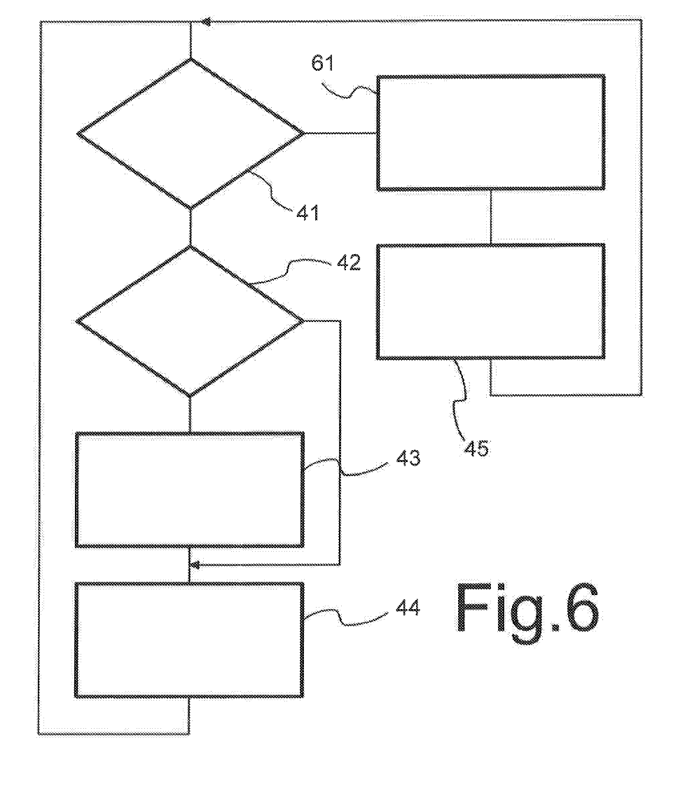

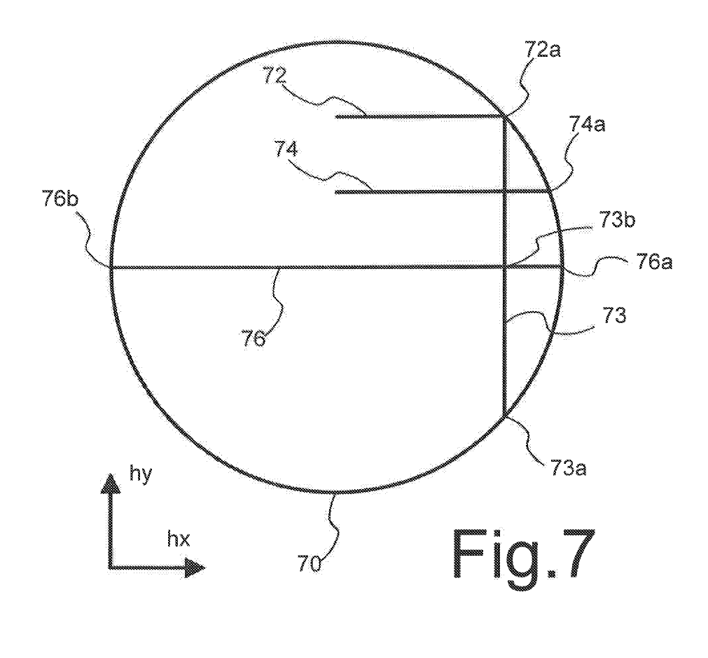

FIG. 6 shows a flow chart of operation of control circuit 26 wherein this form of control is applied. Steps similar to those in FIG. 4 have been given the same number in this flow chart.

In a first step 41, the program causes the microcontroller of control circuit 26 to test whether an overrule state applies. If not the program causes the microcontroller to execute second to fourth steps as in FIG. 4. If first step 41 indicates that the overrule state applies the program causes the microcontroller to execute a first further step 61 wherein the microcontroller sets a direction control value to a first or second value dependent on whether the current count value is above a threshold or not. The threshold preferably corresponds to a half the total count N.

Subsequently, the program causes the microcontroller to execute a version of fifth step 45 wherein the predetermined direction of motor rotation is controlled by the direction control value, so that the mirror is rotated to the slip position that has a count on the same side of the threshold as the count value used in first further step 61. Compared to the embodiment wherein the same predetermined direction is always used, this reduces the time needed for rotating to a slip position at least on average. The threshold preferably corresponds to a half the total count N, in which case the needed time is always reduced, but on average over all starting position other threshold values between 0 and N, e.g. between 40% and 60% of N, also reduce the needed time.

In this embodiment, further step 61 may set the count value for use in first to fourth steps 41-44 to a first or second initial value, e.g. 0 or N, selected according to the selection of the direction control value. Alternatively, a version of fourth step 44 may be used wherein the pre-set value used in fourth step is selected dependent on the direction control value selected when first further step 61 was last previously executed, using a received preset value or a sum of that preset value and the total count N dependent on the direction control value. As another alternative, the preset value may be adapted by the microcontroller, or in control device 29 dependent on the direction control value.

When this embodiment is combined with the steps to supply information about a current angle of the mirror as shown in FIG. 5, a version of fifth step 55 may be used wherein the pre-set value used in fourth step is selected dependent on the direction control value selected when first further step 61 was last previously executed, using a received preset value or a sum of that preset value and the total count N dependent on the direction control value. When applied to power down, a non-volatile or battery backed memory may be used to store the direction control value for use to select the direction control value on subsequent power up and/or adapt preset values after power-up.

In another embodiment a circuit with a function like the embodiment of FIG. 6 may be implemented by adapting the circuit of FIG. 3, or a circuit with a similar function.

As in the case of FIG. 4 a step may be inserted between first step 41 and fifth step 45, to test whether time out and/or slip occurs e.g. based on a time count and/or an output signal form a slip detector, and if so to set motor control to “no-movement”, and optionally terminate the overrule state and return to first step 41.

Use in Mirror Control with Multiple Axes of Rotation

Although examples have been described wherein only one angle of orientation of the mirror is involved, it should be appreciated that an assembly may be provided with a plurality of motors to change angles of mirror orientation around different rotation axes relative to the housing. When the rotation about each of these angles has its own stop independent of the other angles, one or more of these angles may be controlled as described. This may be the case for example when a first actuating mechanism for rotating the mirror about a first axis is mounted on a platform that is rotated by a second actuating mechanism for rotating the mirror about a second axis. In an embodiment, a first motor may be the motor used for power fold, and the other may be a motor for driving rotation of the mirror around an axis of rotation transverse to the power fold direction.

However, an additional problem may arise in a mirror assembly with multiple motor mechanisms, when a first mirror orientation stop angle, at which rotation driven by a first motor meets a stop, is depends on a second mirror orientation angle driven by a second motor. This may occur for example in the mirror assembly disclosed in U.S. Pat. No. 4,281,899. In this type of mirror assembly, the mirror orientation is determined by the heights h1, h2 of different points in the plane of the mirror above a ground plane. Different motors drive the heights h1, h2 of the different points, while the height h0 of a turning point in the plane of the mirror remains constant.

In an exemplary assembly of this type, the mirror meets a stop when the mirror edge meets the ground plane. In the case of a circular mirror, this occurs when the angle between the normals Nm and Ng to the plane of the mirror and the ground plane reach a critical angle, no matter in which direction the normal Nm to the plane of the mirror is rotated from the normal Ng of the ground plane. In mathematical terms this occurs when the sum hx²⁺hy², of the squares of the height offsets hx=h1−h0, hy=h2−h0 to the turning point, reaches a critical value.

FIG. 7 displays a plane wherein different points correspond to different combinations of height offsets and a circle 70 represents combinations of height offsets where the critical angle is reached. First and second lines 72, 74 each represent successive combinations of height offsets that occur when a first motor adjusts a first height while the other motor keeps the second height constant at respective different values for the first and second line 72, 74. As can be seen, the first height offset hx driven by a first motor meets different stops at different values hx corresponding to points 72a, 74a that depend on the second height offset by established by the second motor.

It should be appreciated that although FIG. 7 only corresponds to a specific example of a circular mirror above a flat ground plane, driven by adjusting heights, it has general features that are representative for any mirror assembly, such as assemblies having a non-circular mirror and an uneven ground plane. In general, for other mirror assembly configurations circle 70 may be replaced by another closed contour, and the coordinates hx, hy may represent motor driven parameters other than heights.

As will be appreciated, in this case there is no discrete known orientation at which slipping occurs in the sense described for FIG. 1 and following, i.e. at which rotation driven by an electric motor meets a stop with a discrete predefined orientation and from which the actual angle can be determined solely by counting revolutions. However, it is still possible to determine mirror orientations indirectly. In the example of FIG. 7, chords, i.e. straight lines, such as line 73, between points 72a, 73a on circle 70 may be used to determine the actual mirror orientation, as represented by hx, hy values.

For example, given the orientation and a measured length of a chord, there are only two pairs of points on circle 70 where the chord can be located. Thus, if the mirror has met a stop (which means that its orientation is represented by an as yet unknown point on circle 70) and it is known to have reached the stop from a known direction along a chord of a length given by a count of revolutions, the point on circle 70 that corresponds to the stop, and hence the mirror orientation, can be determined.

Similarly, a line (e.g. line 76) that intersects a chord (e.g. line 73) at right angles halfway along the length of the chord can be defined given the orientation of the chord, without knowing its position. Therefore it can be determined that the mirror orientation is represented by a point on a such a line by determining a count of number of revolutions when moving between the stops at opposite ends of a chord, and then back by half that count. By driving the mirror through orientations represented by positions along such a line until it meets a stop, a known mirror orientation can be determined.

Both methods use a count of revolutions between stops. When such a count is determined in the overrule state it is possible to know certain orientations of the mirror. One example of such a motor driving scheme is illustrated by means of FIG. 7. In this scheme a circuit similar to that of FIG. 3 may be used, but with a first and second motor and a duplication of the components of the control circuit for the respective motors, and a replacement of overrule detector 36 by a state machine to control operation in successive steps in the overrule state. Alternatively control circuit 26 may comprise a microcontroller. Control circuit 26 is configured to cause the mirror to be driven in a first step in the overrule state in a first direction until the rotation meets a first stop. Any first direction may be used, corresponding of rotation of either the first motor or the second motor, or a combination of these motors rotated at a fixed revolution ratio. By way of example, use of rotation of only the first motor is illustrated. The resulting rotation corresponds to first line 72 and the first stop occurs at a point 72a where this first line 72 intersects circle 70.

In this scheme control circuit 26 is configured to perform a second step in the overrule state, wherein control circuit 26 causes movement in a second direction, away from the first stop, until the rotation meets a second stop. To realize the second direction control circuit 26 may be configured to cause the first or second motor to be rotated, or a combination thereof to be rotated at a fixed revolution ratio. E.g. the first motor may be driven in the second direction opposite to the first direction. However, by way of example the second direction will be illustrated using rotation of the second motor only. The resulting rotation corresponds to third line 73 and the second stop occurs at a point 73a where this third line 73 intersects circle 70. In the second step revolutions are counted during movement from the first stop to the second stop (between points 72a, 73a).

The control circuit 26 is configured to determine the angle of orientation of the mirror from this count in a third step in the overrule state of this scheme. The count represents a measured distance between the points 72a, 73a corresponding to the first and second stop. Combined with the known directions of rotation of the motors in the first and second steps, this distance corresponds with unique points 72a, 73a, representing known orientations. Control circuit 26 may then cause count values corresponding to this orientation to be loaded into the counters of revolutions of the two motors, or otherwise to be used as reference values for controlling rotation to stored preset orientations. Optionally, control circuit 26 may be configured to use the count values to control a further movement of the mirror in the overrule state to a predetermined reference orientation, from which control circuit may controlling rotation to stored preset orientations defined relative to that predetermined reference orientation. In the example of the circular mirror combined with a flat ground plane, control circuit 26 may do this mathematically: points 72a, 73a have coordinates hy, −hy, so that hy can be computed from the count. Since the sum hx²⁺hy² has a predetermined value C, the absolute value of hx can be determined by taking the square root of C−hy². The sign of hx follows from the first direction in which the first motor was driven in the first step.

Instead of computing a square root, control circuit 26 may comprise a look-up table to determine the value of hx by look-up. As used herein a look-up table may be implemented as a memory or memory section in control circuit 26 that stores values indicating counts representing known orientations (e.g. hx values) at addresses that are derived from hy (or directly from the count of revolutions between two stops). Thus, control circuit 26 may determine hx and hy representing a known orientation, by deriving the address hy from the count, addressing the memory or memory section with that address and retrieving the indication of hx (or a count value representing hx) from the memory. Control circuit 26 may set the signs of these values according to the first and second direction of rotation (in the example positive for hx because left to right movement along first line 72 was uses and negative for hy, because top down movement along third line 73 was used). As used herein, look-up may comprise interpolation between values from addresses for nearest higher and lower hy values for which hx values are stored.

More generally, look up may be performed by any parameterized function of hy instead of such an interpolation, using stored parameters to define pieces of the parameterized function. As will be appreciated the content of the look-up table may be adapted to the configuration. In this way, other configurations than a circular mirror above a flat ground plane can easily be handled. The content may represent hx, hy values or other values, such as counts corresponding to hx and hy values or other motor controlled features may be used instead of hx, hy.

The look-up table content may be selected in a calibration process based on measurements. For example, during calibration the mirror may repeatedly be positioned in a known reference orientation, and rotated by the first motor each time by a different first count of revolutions, then rotated by the second motor until a stop is reached (cf. point 72a) after which a second count of revolutions needed by the second motor to move between two stops is counted (cf. between points 72a, 73a). This second count may than be converted into an address in the look-up table and the first count may be stored at this address.

Although one process of determining the angle of orientation of the mirror from a count between stop positions has been described, it should be appreciated that other processes may be used to reach a known mirror orientation. For example, after the first and second step of movement along first line 72 and third line 73 a first and second and further step may be added. In the first further step only the second motor is driven, backing up from the second stop (position 73a) and counting revolutions until half the count between the first and second stop is reached (point 73b).The effect is that it is known that the mirror has one of the orientations represented by the line 76. In the second further step only the first motor is driven, in the first direction until the rotation meets a third stop (point 76a) along a fourth line 76 (alternatively a direction opposite to the first direction may be used to reach point 76b, but this will take longer).

After this the mirror is a predetermined position mid-way the by range and at a predetermined extreme of the hx range. The mirror orientation is then in a known position corresponding to point 76a (or 76b), from which any mirror orientation can be measured by counting revolutions used to arrive at said orientation. Stored counts for preset orientations relative to this orientation count can then be used to control positioning of the mirror using the motors.

However, this is but one way of reaching such a predetermined orientation. Optionally, in further step only the first motor is driven in the first direction until it meets another stop opposite the first direction until the rotation meets a fourth stop (point 76b) along the fourth line 76, while counting a further count of revolutions between the stops (points 76a, b). The first motor may subsequently be driven back in the first direction (along fourth line 76) until half the further count of revolutions is counted. In this way the mirror orientation is known to be in the middle of its range. Stored counts for preset orientations relative to this orientation count can then be used to control positioning of the mirror using the motors.

Counting while a first one of the motors is driven to a stop positions after the second one of the motors has previously been driven to a count halfway between its stop positions has the advantage that errors due to movement at glancing angles to the stops can be reduced.

Many other processes may be used to reach known orientations. This may involve simultaneous motion of the motors at a fixed ratio of revolutions instead of driving one motor at a time, using, back and forth motion etc. As will be appreciated, this kind operation in the overrule state may take many seconds to complete until a known orientation of the mirror is reached. To reduce the delay, it is preferred that at least part of the movements along the various lines 72, 73, 76 are performed automatically when the vehicle is switched off, and/or when new preset count values have to be stored.

1. An adjustable vehicle mirror assembly, the assembly comprising
an electric motor, a mirror and a gear train for translating rotation of the electric motor into changes of an angle of orientation of the mirror, the gear train comprising a disengaging coupling;
a motor power supply and direction control switch coupled to the motor;
a revolution sensor for detecting revolution of an element in the gear train or a rotation axle of the electric motor;
a control circuit coupled to the revolution sensor and the motor power supply and direction control switch, the control circuit being configured to
determine a count of a number of net full or partial revolutions of the element based on signals from the revolution sensor, and to control supply of power to the motor and its direction dependent on whether the count indicates that the number of net full or partial revolutions has reached a preset value,
determine a count value corresponding to a known mirror orientation by switching to an overrule state and controlling supply of power to the motor and its direction automatically according to a predetermined direction when in the overrule state, a least state until the disengaging coupling reaches a disengaged state and/or until the electric motor stalls because a transmitted torque exceeds a threshold.

2. An adjustable vehicle mirror assembly according to claim 1, wherein the control circuit comprises a power-down state detector, the control circuit being configured to switch to the overrule state in response to detection of the power down state by the power-down state detector.

3. An adjustable vehicle mirror assembly according to claim 1, wherein the control circuit is configured to switch to the overrule state on power-up and, when the disengaging coupling has reached a disengaged state and/or when the electric motor stalls, to switch to said control of supply of power to the motor and its direction dependent on whether the count indicates that the net full or partial revolutions have reached a preset value.

4. An adjustable vehicle mirror assembly according to claim 3, wherein the control circuit comprises a power-down state detector, the control circuit being configured to switch to the overrule state also in response to detection of the power down state by the power-down state detector.

5. An adjustable vehicle mirror according to claim 1, further comprising an ASIC wherein the control circuit is implemented as an embedded circuit, the ASIC comprising a bus communication interface for controlling setting of the preset value via an in vehicle bus.

6. An adjustable vehicle mirror assembly according to claim 1, further comprising a mirror housing, the gear train being configured to translate rotation of the electric motor into changes of an angle of orientation of the mirror relative to the mirror housing.

7. An adjustable vehicle mirror assembly according to claim 6, comprising a power-down state detector and a power fold mechanism configured to rotate the mirror housing relative to the vehicle in response to detection of the power down state by the power-down state detector, the control circuit being configured to switch to the overrule state synchronized with activation of the power fold mechanism.

8. An adjustable vehicle mirror assembly according to claim 1, wherein the control circuit is configured to select the predetermined direction according to whether the value of the count when switching to the overrule state is above or below a threshold value.

9. An adjustable vehicle mirror assembly according to claim 1, wherein the control circuit is configured to control supply of power to the motor and its direction in the overrule state to rotate starting from a first disengaged position or motor stall position until a second disengaged position or motor stall position is reached, to obtain a further count of full or partial revolutions detected during rotation between the first and second disengaged position, and to use the further count to control subsequent rotation.

10.-11. (canceled)

12. An adjustable vehicle mirror assembly according to claim 9, wherein the control circuit is configured to control supply of power to the motor and its direction in the overrule state to rotate the motor back from the second disengaged position or motor stall position towards the first disengaged position or motor stall position until half said further count counted from the second disengaged position or motor stall position.

13. (canceled)

14. An adjustable vehicle mirror assembly according to claim 1, wherein the control circuit comprises a timer and/or a disengagement detector configured to detect an indication of disengagement of the disengaging coupling, the control circuit being configured to switch off the overrule state in response to detection by the timer that a predetermined time interval has elapsed since switching to the overrule state and/or in response detection of the indication of disengagement by the disengagement detector.

15. An adjustable vehicle mirror assembly according to claim 1, further comprising a detector for detecting an effect associated with external mirror adjustment, the control circuit being configured to switch to the overrule state in response to detection of said effect.

16. An adjustable vehicle mirror assembly according to claim 15, wherein the gear train is coupled to the electric motor so that the gear train transmits manual adjustment as rotation to the electric motor, the adjustable vehicle mirror assembly comprising an induction detector coupled to the electric motor, the control circuit being configured to switch to the overrule state in response to detection of an induction current or voltage from the electric motor.

17. An adjustable vehicle mirror assembly according to claim 15, comprising a pressure controlled switch connected to the mirror so as to switch when a pressure is exerted om the mirror, the control circuit being configured to switch to the overrule state in response to switching of the pressure controlled switch.

18. An adjustable vehicle mirror assembly according to claim 15, comprising a clutch between the drive chain and the mirror, the control circuit being configured to switch to the overrule state in response to detection of declutching of the clutch.

19. (canceled)

20. An adjustable vehicle mirror assembly according to claim 15, further comprising a capacitor and a circuit for charging or discharging the capacitor in response to detection of said effect, the control circuit being configured to compare a voltage over the capacitor or a charge stored on capacitor with a reference value and to the switch to the overrule state dependent on a result of said comparison.

21. An adjustable vehicle mirror assembly according to claim 15, wherein the control circuit is configured to detect play by comparing an initial current, which flows through the electric motor initially after a voltage is applied to the electric motor, with a reference value and to switch to the overrule state in response to detection that the initial current is below a threshold value.

22. An adjustable vehicle mirror assembly according to claim 15, further comprising sensing means configured to detect when the mirror orientation assumes a predetermined position, the control circuit being configured to switch to the overrule state in response to detection that said count differs by more than a predetermined amount from an expected count for that predetermined position at a time point for which the sensing means detect that the mirror orientation has assumed the predetermined position.

23. An adjustable vehicle mirror assembly according to claim 22, comprising an optical detector and an optical marker on respective parts of the mirror assembly between which relative motion will occur when the electric motor drives the mirror, the optical detector being coupled to the control circuit, the control circuit being configured to obtain said time point from a time of detection of the optical marker by the optical detector.

24. An adjustable vehicle mirror assembly according to claim 22, wherein the control circuit comprises a memory for storing a temporal motor current fingerprint, the control circuit being configured to compute correlation between a measured motor current pattern and the stored fingerprint from said memory as a function of time and to determine said time point from occurrence of a maximum in said correlation.

25. An adjustable vehicle mirror assembly according to claim 1, further comprising a motor power supply and a power supply line coupling the motor power supply to the electric motor, the revolution sensor comprising a current ripple detector coupled to the power supply line of the electric motor.
